(19) United States
(12) Patent Application Publication
(10) Pub. No.: US 2017/0193430 A1
(43) Pub. Date: Jul. 6, 2017

(54) RESTOCKING SHELVES BASED ON IMAGE DATA

(71) Applicant: International Business Machines Corporation, Armonk, NY (US)

(72) Inventors: Priscilla BARREIRA AVEGLIANO, Sao Paulo (BR); Carlos Henrique CARDONHA, Sao Paulo (BR); Andrea Britto MATTOS LIMA, Sao Paulo (BR); Diego SANCHEZ GALLO, Sao Paulo (BR)

(21) Appl. No.: 14/985,626

(22) Filed: Dec. 31, 2015

(51) Int. Cl. G06Q 10/08; G06K 9/52; B64C 39/02; G06K 9/00; G06K 9/20; G06T 7/00; G06T 5/00

(52) U.S. Cl. CPC G06Q 10/087; G06T 7/0008; G06T 7/0042; G06K 9/52; G06T 5/006; G06K 9/00744; G06K 9/2063; B64C 39/024; G06T 2207/30204; B64C 2201/165; B64C 2201/127; B64C 2201/146; B64C 2201/141

(57) ABSTRACT

To identify spaces on shelves which are not full of product and need restocking, markers having a pattern are placed on or near shelves containing product. A camera obtains an image of the shelf, products, and markers. A processor executing software is used to analyze the image to identify the markers and the shelf. Next, storage areas on the shelf are analyzed to identify vacant areas represented by a lower light intensity relative to adjacent areas. The processor determines a location of the vacant areas, and determines the size of the vacant areas using the known marker size and the size of the marker in the image, to generate a scale which is applied to the vacant area. This information and stored product information is used to determine which products should be restocked. The marker pattern can be selected to be readily recognizable by an image processing algorithm.

### FIELD OF THE DISCLOSURE

The disclosure relates to a system and method for identifying product to be restocked on shelves, and more particularly, to using markers captured by image data to determine the size of vacant shelf area.

### BACKGROUND OF THE DISCLOSURE

Monitoring the availability of products upon market shelves is a time and labor intensive task that is typically performed by market employees. Monitoring is necessary in order to ensure that all stocked products have representative quantities on display shelves, so that such products can be purchased. Additionally, marketing agreements with suppliers may require that product is properly stocked at all times.

### SUMMARY OF THE DISCLOSURE

In an embodiment of the disclosure, a method of identifying spaces on shelves which are not full of objects, comprises placing a marker bearing a pattern, the marker having known dimensions, proximate a shelf containing objects; obtaining an image of the shelf including the marker, using a device having a camera; executing software stored on non-transitory media using a processor of at least one of the device having a camera and a computer, the software configured to analyze the image to identify the marker; analyze the image to identify the shelf; analyze the storage area of the shelf to identify vacant areas of the shelf represented by a lower light intensity relative to adjacent areas; determine a location of the vacant areas with respect to the shelf; determine the size of the vacant areas using the actual size of the marker and the size of the marker in the image, to generate a scale which can be applied to the vacant area; and process the determined information and stored information pertaining to the objects to determine what objects are missing from the vacant areas.

In another embodiment of the disclosure, a method of identifying spaces on shelves which are not full of objects, comprises placing a marker bearing a pattern, the marker having known dimensions, proximate a shelf containing objects; obtaining an image of the shelf including the marker, using a device having a camera; executing software stored on non-transitory media using a processor of at least one of the device having a camera and a computer, the software configured to analyze the image to identify the marker; analyze the image to identify the shelf; identify areas of the shelf in relation to a planogram; analyze the storage area of the shelf to identify vacant areas of the shelf by comparing adjacent areas of the shelf with reference to the planogram, and if the planogram indicates adjacent areas are intended to contain the same product but the corresponding adjacent areas of the image appear different, determining that at least one row includes a vacant area; and communicate the location of the vacant areas for subsequent restocking.

In a further embodiment of the disclosure, a method of restocking product on store display shelves, comprises placing a marker bearing a pattern proximate a shelf containing objects; at predetermined time intervals, obtaining an image of the shelf including the marker, using a device having a camera; executing software stored on non-transitory media using a processor, the software configured to analyze the image to identify the marker; use the marker location to identify areas corresponding to a planogram; and compare stored image data of a product at an identified area that is fully stocked with image data obtained at a time interval, and if the stored image and the image data obtained at a the time interval are not the same, designating the identified area and product as requiring restocking.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 depicts a product display shelf, including markers of the disclosure;

FIG. 2 depicts an example marker of the disclosure;

FIG. 3 depicts an image of a shelf as viewed upon the display of a smartphone in communication with a computer server;

FIG. 4 depicts a diagrammatic illustration of the image of FIG. 3, de-skewed, and with vacant areas identified;

FIG. 5 depicts a drone adapted to obtain images in accordance with the disclosure, the drone in communication with a computer server;

FIG. 6 depicts a processing component of the drone of FIG. 5;

FIG. 7 depicts a drone obtaining images of product upon shelving;

FIG. 8 illustrates an example computer or server, all or portions of which can be used to carry out the disclosure; and

FIG. 9 illustrates an example mobile computing device, all or portions of which can be used to carry out the disclosure, for example in a smartphone, drone, or other portable computing device.

### DETAILED DESCRIPTION OF THE DISCLOSURE

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

In accordance with the disclosure, vacant display or shelf space is identified without a requirement of human intervention. More particularly, markers 110 of known peripheral dimensional measurement are placed upon the shelves 120, and an image obtained of shelf 120, together with marker 110, includes sufficient information to provide a scale, whereby it is possible to determine dimensions of other objects within the image, including a size of vacant areas upon a shelf 120. While two levels of shelves 120 are illustrated, it should be understood that system 100 of the disclosure can be used with any number of shelves, arranged in any configuration, and having any number of levels.

Markers 110 can bear a distinctive pattern, which is accurately and reliably recognized by image recognition software. For example, as shown in FIG. 2, marker 110 forms a pattern of 9 blocks, which form a contrasting pattern. The pattern is selected to be very unlikely to occur in a typical shelf image. Further, markers 110 can be placed at specific locations which further reduce the likelihood of a false positive recognition, for example, at extreme edges of shelves 120.

While forming a distinctive and unique appearance relative to a pattern which may be expected to appear on product 150 upon shelves 120, markers 110 may further encode human or machine readable information. For example, a marker 110 on a left or beginning side of a shelf 120 can indicate a row start, and a marker on a right or end portion of shelf 120 can indicate a row end. Alternatively or additionally, the pattern can encode a unique shelf number, shelf section number, row number, specific product area, or the type of product to be stored at an area proximate the marker. The pattern can alternatively or additionally encode an ID for the marker, and the ID can correlate to a database where any of the foregoing information, or other information, is stored in association with the marker. Herein, the term ‘product’ is used, however it should be understood that the disclosure can be used to identify present or absent objects of any type, including for example inventory items, for sale items, or any other type of collection or stock.

For example, marker 110 can form a pattern that includes one or more of a bar code or QR Code, as well as human readable indicia, which can facilitate location of marker 110 in a correct location. In an embodiment, a bar code upon marker 110 is scanned and assigned to a location where it has been placed, using a handheld computing device connected to a computer database, either locally stored or stored remotely. In another embodiment, a code upon marker 110 is identified and recognized by an image recognition software algorithm that is executed by server 700.

In FIG. 3, an image of a shelf section has been captured using a digital camera, or a camera of a smartphone or other portable computing device 140. The image, which can be a video or streamed video, can be processed as described herein, in part or entirely, using an application executing within the smartphone. However, to leverage information for multiple store locations, it can be advantageous to obtain and process the image data at a remote server. Accordingly, the shelf images can be identified as to a store location, time of day, shelf section, or any other criteria, using an application of the smartphone, and sent in any known or hereafter developed manner 280 to a remote server 700 connected to the Internet or ‘cloud’, including transmission first via a local network, such as WiFi, BLUETOOTH, or a USB connection, followed by transmission using a longer range network, such as the Internet. Direct transmission from the smartphone to the Internet can also be carried out. A camera herein includes a device which captures still images or video images.

Identification of the image, including particulars of the shelf section photographed, can be manually input by the person gathering data. Alternatively, a location of the smartphone can be known using location services of the smartphone, which can include WiFi triangulation, GPS if outdoors, or any other known or hereafter developed method, and this location information can be associated with the image before processing and/or transmitted to the remote server. If a location of the smartphone or the image taken is determined, either using location services of the smartphone or using information provided by markers 110, or location data provided by other means, this location information can be correlated with a stored planogram or other product placement database, and software executing upon one or more of the smartphone, one or more local servers, and one or more remote servers, the computing device(s) and software collectively referred to hereinafter as system 100, to determine which products belong upon the shelf captured by the image, and a particular arrangement for such products on the shelf, and which products require restocking.

With reference to FIG. 4, to determine restocking requirements, system 100 first detects which shelf positions are not fully stocked. In accordance with the disclosure, system 100 determines which areas of the shelves do not have product extending to the forward region of the shelf, which is indicative of a less than fully stocked condition. This condition results in vacant areas 302, shown in hatching in FIG. 4.

In one embodiment, vacant areas can be identified by less illuminated or shadowed regions of display area in the image(s). If the image data is in the form of a video, one or more representative frames can be selected by system 100 for analysis. More particularly, markers 110, or other indicators, including for example a linear extent of shelving, can be used by system 100 to identify areas within the image which should contain products. Light levels within particular display areas can be compared with adjacent areas to determine areas of reduced reflection or reduced light level. The stored planogram can be consulted by system 100 to determine if a particular display area should contain the same product as an area to the left or right of the particular display area. If there is a difference in reflectivity or light level in adjacent areas known to contain the same product, it may be determined that a condition exists requiring restocking. It should be understood that shelf herein includes any form of object display, including postcard display racks, pegboard display, hanging displays, industrial or warehouse racking, and objects stacked vertically one on top of another.

Similarly, images can be obtained of a fully and properly stocked display area under particular light conditions, and such images can be compared with images obtained later during store hours, to detect areas in the display areas of the images which have a changed light level, indicative of a change in stocking level for the display area.

In another approach of the disclosure, where adjacent rows of products are known to contain identical products, for example by using the stored planogram, it can be determined if the first product in each row is at the same depth of field, for example using the size of text on the product packaging. If adjacent rows exhibit a different depth of field, it is known that at least one row has missing product. The size of text upon the product 150 package in the image can be compared with a known size of text from the planogram or other product database, and the image text size can further be compared with a scale obtained from marker 110. In this manner, it is possible to determine if the image text is smaller than it would be if a product 150 package was at the front of the row, indicating that the particular product package being viewed is a distance back from the front of the row, and that product in front has been removed, and may need to be restocked.

Once it is determined which display row has missing product, the size of the vacant area can be determined with reference to objects of known dimension within the image. Markers 110 have a known dimension and shape, and therefore can be used as a scale and compared with the dimension of the vacant area identified as described above. System 100 can then determine the size of any particular vacant area. Accordingly, for vacant area 302-1 of FIG. 4, width W′ relates to width W of marker 110 of FIG. 2, and height H′ correlates to height H of FIG. 2. With this information, an identification of the missing product can be further validated, for example if the vacant area is about the size of a particular product, or a multiple of the size of a particular product. The planogram can also be compared with the size obtained, to determine the number of rows which have missing product, based on the sizes of product faces stored together with, or linked to, the planogram information. Size information can additionally be derived by comparing a known distance between markers 110 with a relative separating distance in the image.

To obtain an accurate estimate of the actual size of a vacant area, system 100 can determine an extent to which the image was skewed or distorted during image capture, and can use markers 100 as a guide, as markers 100 have a known size and shape, for example a square or rectangle of known height and width. The deviation from the marker's original shape can enable a determination of the extent of skewing that has taken place within a remainder of the image, and either resultant calculations can be de-skewed using a transformation function T, or the entire image can be de-skewed before further calculations are carried out. The transformation function T can be carried out on the image before calculating vacant space, or T can be applied to area values determined using the skewed image.

Next, the location of the vacant space can be determined. More particularly, the scale provided by marker 110 further enables determining a location along the shelf where the vacant area is located. As shown in FIG. 4, a horizontal offset from a leftmost edge of shelf 120, for vacant space 320 is indicated by arrow X, and a vertical offset is indicated by arrow Y. The horizontal and vertical offset to a vacant space can be determined using the scale provided by markers 110. Edges of shelves are distinctive, and can be reliably located using object recognition, although shelf edges can be provided with markers 110 which indicate a shelf edge. Alternatively, a plurality of markers 110 can be applied to shelf 120, where the markers are spaced at a known relative distance, and a location of a vacant space can be determined with reference to these spaced apart markers. For larger displayed objects, it may be known with sufficient accuracy where a vacant space is based on location information determined by the smartphone or other device when the image was captured. Offset data can be compared with a planogram or other shelf layout to determine which product belongs at a given location.

Having carried out the foregoing analysis, system 100 can now recommend product for restocking. In order to determine the exact quantity which should be brought from the stockroom to the shelves, or reordered, it is necessary to determine how many products are missing from display areas having vacant spaces 302. In one approach of the disclosure, as product is removed from a shelf, a side profile of identical product in an adjacent row is revealed. This side profile can be used to identify the number of items revealed, for example using vertical lines in the image. Side dimensions of product can also be obtained from the planogram and stored data relating to the product, and this information can be used to validate the estimated number of revealed products. This analysis can be aided by having complementary images taken from different approach angles.

In an alternative of the disclosure, a sensor is used to measure the depth of vacant areas or all areas of display shelves. While the disclosure can effectively be used to identify vacant areas for restocking without a calculation of depth, it may be desirable in some circumstances to have this additional information. In one alternative, an employee can carry a device which measures the depth of shelves as they are passed by. The employee can hand carry the device, the device can be connected to a shopping cart or other conveyance. Alternatively, the employee can ride a SEGWAY or other type of scooter, and the device can be either held or mounted to the scooter. The device can also incorporate the camera used to obtain the images or video. The distance measurement device can be of any known type, including for example sonar or laser. System 100 can use compare depth at multiple locations to determine not only if a vacant area is present, but also the depth of the vacant area.

A location of a depth reading along a product display can be determined by comparing a time when an image was obtained with a time when a depth reading was taken. Additionally or alternatively, a location where a depth reading was taken can be obtained if a starting location and time, and a travel speed while readings were taken, are known.

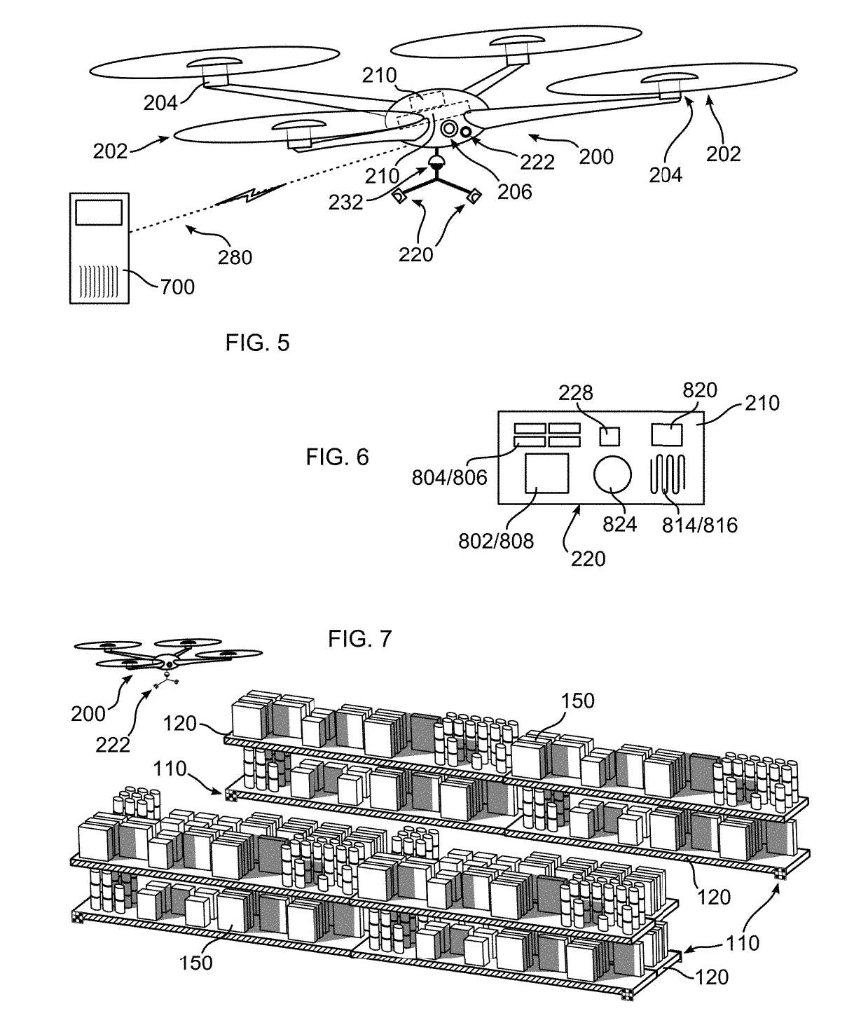

FIGS. 5-7 illustrate an alternative to having an employee carry out such image gathering and/or depth readings. More particularly, a drone 200 carrying one or more cameras 220 and/or one or more depth measuring devices 222 can fly along rows of displayed product, gathering image/video data, as well as taking depth readings, if desired. Cameras 220 can be carried by a gimbal 232 or cable, to promote a consistent frame of reference within the images.

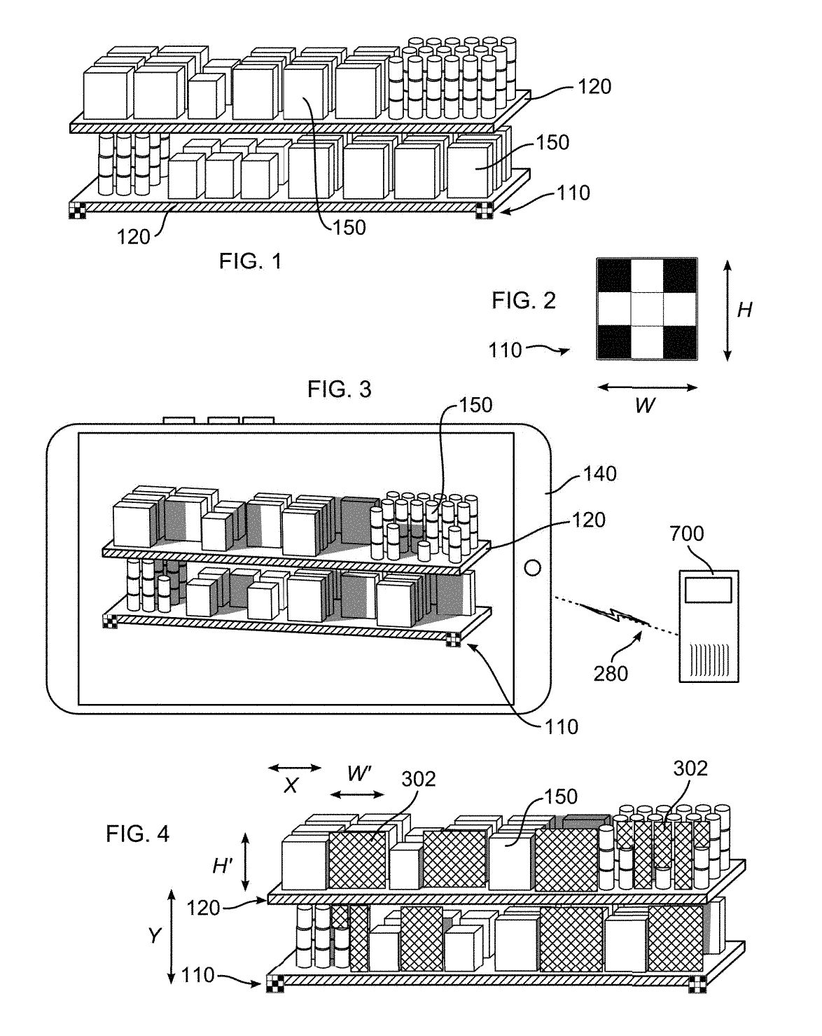

More particularly, and with reference to FIG. 5, system 100 of the disclosure can further include at least one unmanned aerial vehicle (UAV) or drone 200, and an optional server 700. At least one of the drones 200 and servers 700 have an electronic processing circuit configured to execute machine instructions to carry out the tasks described herein. Drone 200 and server 700 are configured to communicate with each other wirelessly during flight operation of drone 200, for example using a short or long range wireless communication protocol 280, examples including WiFi, WiMAX, BLUETOOTH, SIGFOX, 3G, 4G, LTE, or another protocol, for example using a publicly available frequency, diagrammatically illustrated in FIG. 1. Drone 200 can have varying amounts of processing capability, but includes at least sufficient processing capacity to fly, and further includes the components normally associated with a UAV, such as a means of propulsion, for example one or more propellers 202 driven by a motor 204, a battery 206, one or more navigation cameras 206, a control circuit 210 including flight related sensors and electronics and software, and communications electronics, including wireless two way communication for remote or semi-autonomous control, although drones of the disclosure can be implemented as fully autonomous.

A four propeller drone is illustrated, although any drone configuration that can fly within a store or other anticipated area of deployment can be used, provided it has sufficient strength to carry the cameras 220 and ranging devices 222. For clarity, propeller guards are not illustrated. However, it should be understood that safety equipment can be provided, particularly as drone 200 is expected to fly near humans. Likewise, while any size drone can be used, it should not be larger than required for the intended mission as described herein, to reduce potential harm due to collision or other failure.

Control circuit 210 is diagrammatically illustrated in FIG. 6, and as mentioned, includes electronics 228 necessary to carry out flight in accordance with an intended mission, whether that is remote piloted, semi-autonomous, or fully autonomous. In an embodiment of the disclosure, drone 200 can carry out all processing tasks described herein relating to capturing and analyzing images and ranging data. However, it should be understood that such tasks can be shared or divided between drone 200 and server 700 as desired, using wireless transmission of data between drone 200 and server 700.

Other components of control circuit include non-transitory memory 224 coupled to an electronic processor circuit, such as a microprocessor 802 and/or a digital signal processor 808, a battery to preserve a configuration state, one or more antennas 814/816.

In FIG. 7, drone 200 is depicted flying between opposing rows of shelving 120. Two cameras 220 and/or two depth measuring devices 222 can be provided upon drone 200, so that adjacent rows can be imaged simultaneously, with a single pass of drone 200. Drone 200 can pass along all rows of a store during a single flight session, or can fly along given rows at intervals, where certain more active rows have more frequent overflights. Drone 200 can conduct flights either autonomously or under human control, and either or both of while a store is open for sales, and outside sales hours.

System 100 can determine an order in which shelves are analyzed, and in which depleted shelves are restocked, for example giving priority to high traffic shelves, high profit shelves, high volume shelves, or shelves exhibiting a high quantity or large size of vacant areas. Data obtained from a determination of restocking needs in accordance with the disclosure can be used for future product planning, not only by the store but by manufacturers and competitors, to better understand the nature of product sales. Such information can include sale velocity, timing of sales during the day, week, month or year, and a comparison of sales using different placement locations, display arrangement, or product appearance.

Thus, in an illustrative process of an embodiment of the disclosure:

1) a user, such as an employee of a retail store, attaches markers 110 to shelves 120 that will be monitored by a system 100 of the disclosure;

2) the user stores the real dimensions of the markers, or a known distance between markers, within system 100 or at a location accessible by system 100;

3) the user captures one or more images, for example using an application deployed on a smartphone, of one or more shelves 120 bearing markers 110;

4) the smartphone 140 submits the image to a remote server 700, using for example WiFi and/or the Internet;

5) image processing software executing on the server 700 identifies one or more markers 110 in the image;

6) an algorithm of the software computes a transformation function T that converts the input image to a new altered image, where the dimensions of the identified marker(s) 110 are adjusted by a ratio to those of the actual ones, determined in advance in step 1;

7) the image processing software identifies vacant spaces in the transformed image and estimates their area, given the ratio from step 6; and

8) product restocking is determined at least in part from the sizes of the vacant spaces.

The disclosure can be used to enable tasks that are highly relevant for retailers. In particular, the disclosure enables the calculation of shelf replenishment routes. Retailers attempt to avoid situations where customers face on-shelf unavailability of products which are otherwise available in a local stockroom. With output from system 100 detailing the location and size of vacant shelf areas, it becomes possible to compute replenishment routes using this near or real-time information relating to a current stocking level of display shelves. More particularly, a replenishment strategy is computed where shelves with more vacant space available are replenished faster and/or with more items. Sales velocity and demand of a certain product can also be estimated where system 100 is deployed at a frequency corresponding to the target information. For example, to carry out daily analyses, it can be useful if images of the shelf containing the target product are taken and analyzed by system 100 every two hours. Moreover, manufacturers of consumer packaged goods (CPGs) can use this information to not only estimate the sales performance of their product, but also of their competitors.

In an embodiment, preexisting objects within an image of known dimensions can serve as markers, if they can be readily recognized by an image processing algorithm. In this manner, the markers 110 that are manually placed by users to appear within an image can supplemented by these known and recognizable objects, and in some cases replaced by them, where they fulfill certain functions of markers 110. In one application of this, the size of an oil leak in the ocean can be determined based upon known and recognizable markers nearby, such as an oil drilling platform, or an identified ship.

The disclosure can further be used to identify vacancies, and to carry out corresponding planning, for other scenarios in which it is desired to quickly determine space availability. For example, images can be obtained of a parking lot to identify empty spots. Markers 110 can be placed on the ground, and with this frame of reference, marked or unmarked spaces can be identified using aerial photos, which can be taken by drone as described herein, or by other flying craft.

In addition to the aforedescribed vehicle parking and oil leak scenarios, the disclosure can be used to determine density of items which are not product. For example, the disclosure can be used to determine cloud density to enable calculations of solar irradiance, for example. In each case, markers 110 can be positioned upon the ground or otherwise placed within the field of view of the images, and processing can be carried out as described herein. An additional example is estimating the size of holes in pavement, where markers 110 indicate a scale of any holes imaged, and holes appear as vacancies in a field of view, as otherwise described herein. In a yet further example, aerial images can be obtained of a populated area, and a building density can be determined with markers 110 placed within the field of view, and the absence of rooftops indicative of a vacant area, and vice versa. In all the aforementioned examples, markers can also be replaced by any reference objects with known dimension previously present in the scene.

Additionally, while the disclosure describes a retail store, it should be understood that shelves 120 can be warehouse racks and pallet positions, and markers 110 can be placed upon these racks, and vacancies can be determined in the same manner as described herein with respect to retail product placement. For warehouse racking, depth is often not a condition, as a pallet position is either occupied or not, and thus depth calculations can be omitted.

Example Computing System

FIG. 7 illustrates the system architecture for a computer system 700 which can be a computer server, and which can include the functions of a process controller, or other processor on which or with which the disclosure may be implemented. The exemplary computer system of FIG. 7 is for descriptive purposes only. Although the description may refer to terms commonly used in describing particular computer systems, the description and concepts equally apply to other systems, including systems having architectures dissimilar to FIG. 7. Computer system 700 can control temperatures, motors, pumps, flow rates, power supplies, ultrasonic energy power generators, and valves, using actuators and transducers. One or more sensors, not shown, provide input to computer system 700, which executes software stored on non-volatile memory, the software configured to received inputs from sensors or from human interface devices, in calculations for controlling system 200.

Computer system 700 includes at least one central processing unit (CPU) 705, or server, which may be implemented with a conventional microprocessor, a random access memory (RAM) 710 for temporary storage of information, and a read only memory (ROM) 715 for permanent storage of information. A memory controller 720 is provided for controlling RAM 710.

A bus 730 interconnects the components of computer system 700. A bus controller 725 is provided for controlling bus 730. An interrupt controller 735 is used for receiving and processing various interrupt signals from the system components.

Mass storage may be provided by DVD ROM 747, or flash or rotating hard disk drive 752, for example. Data and software, including software 102 of the disclosure, may be exchanged with computer system 700 via removable media such as diskette, CD ROM, DVD, Blu Ray, or other optical media 747 connectable to an Optical Media Drive 746 and Controller 745. Alternatively, other media, including for example a media stick, for example a solid state USB drive, may be connected to an External Device Interface 741, and Controller 740. Additionally, another computing device can be connected to computer system 700 through External Device Interface 741, for example by a USB connector, BLUETOOTH connector, Infrared, or WiFi connector, although other modes of connection are known or may be hereinafter developed. A hard disk 752 is part of a fixed disk drive 751 which is connected to bus 730 by controller 750. It should be understood that other storage, peripheral, and computer processing means may be developed in the future, which may advantageously be used with the disclosure.

User input to computer system 700 may be provided by a number of devices. For example, a keyboard 756 and mouse 757 are connected to bus 730 by controller 755. An audio transducer 796, which may act as both a microphone and a speaker, is connected to bus 730 by audio controller 797, as illustrated. It will be obvious to those reasonably skilled in the art that other input devices, such as a pen and/or tablet, Personal Digital Assistant (PDA), mobile/cellular phone and other devices, may be connected to bus 730 and an appropriate controller and software, as required. DMA controller 760 is provided for performing direct memory access to RAM 710. A visual display is generated by video controller 765 which controls video display 770. Computer system 700 also includes a communications adapter 790 which allows the system to be interconnected to a local area network (LAN) or a wide area network (WAN), schematically illustrated by bus 791 and network 795.

Operation of computer system 700 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 705 coordinates the operation of the other elements of computer system 700. The present disclosure may be implemented with any number of commercially available operating systems.

One or more applications, such as an HTML page server, or a commercially available communication application, may execute under the control of the operating system, operable to convey information to a user.

Example Mobile Computing System

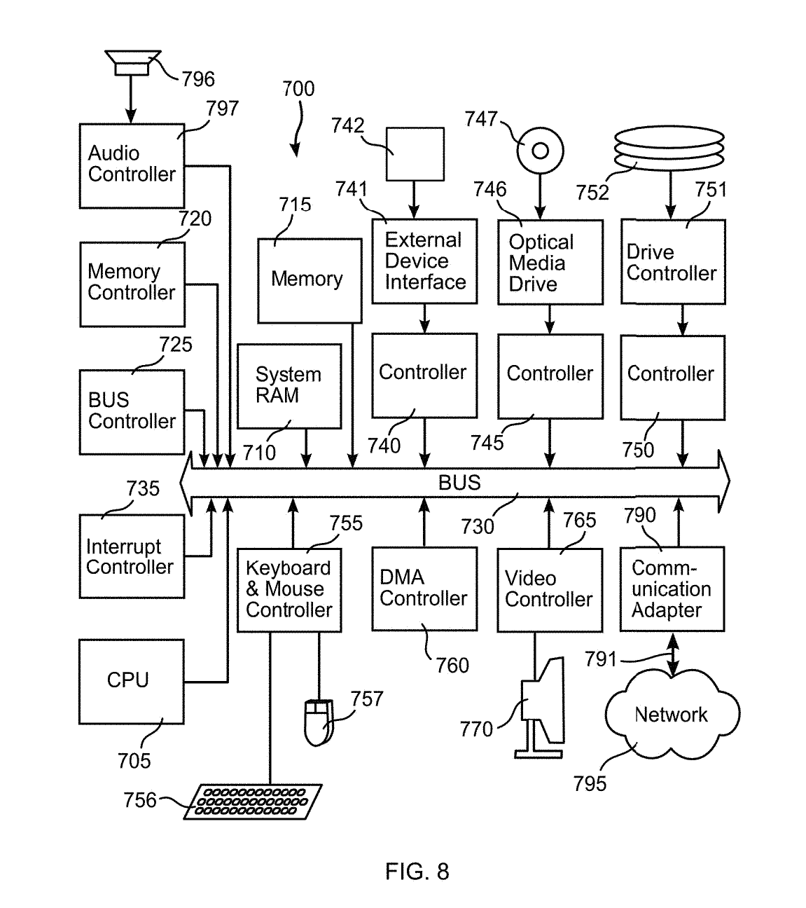

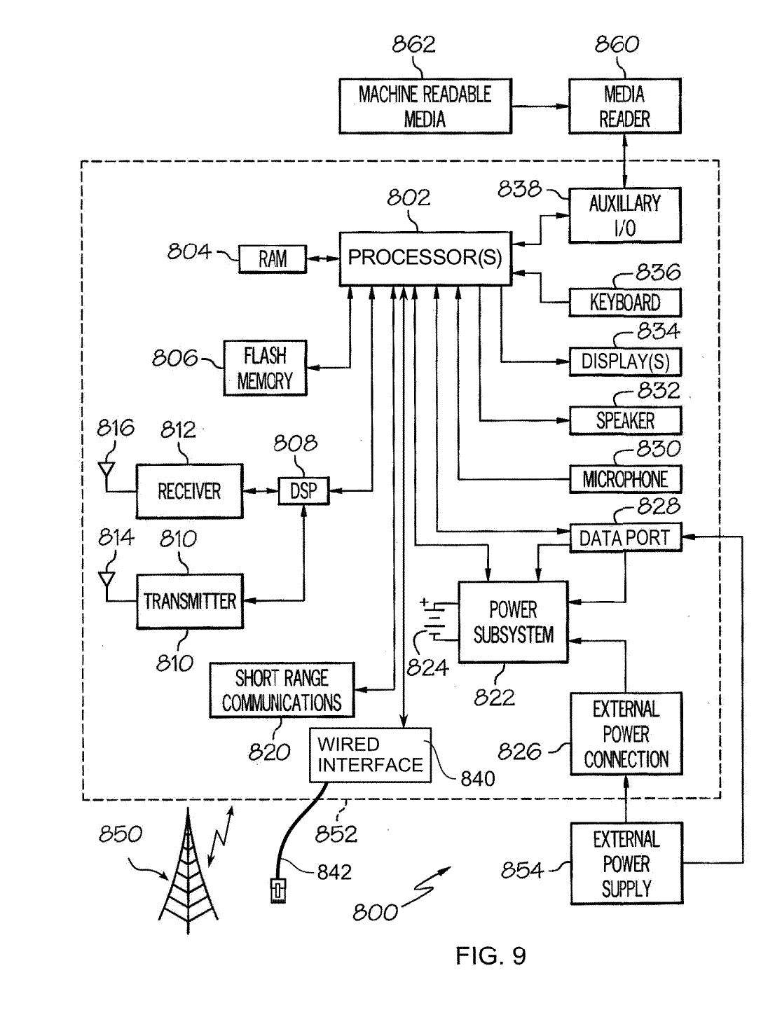

FIG. 8, is a block diagram of an electronic device and associated components 800, which can be used in carrying out the disclosure. Mobile computing device 300 can include one or all of the components of device 800. In this example, an electronic device 852 is a wireless two-way communication device with voice and data communication capabilities. Such electronic devices communicate with a wireless voice or data network 850 using a suitable wireless communications protocol. Wireless voice communications are performed using either an analog or digital wireless communication channel. Data communications allow the electronic device 852 to communicate with other computer systems via the Internet. Examples of electronic devices that are able to incorporate the above described systems and methods include, for example, a data messaging device, a two-way pager, a cellular telephone with data messaging capabilities, a wireless Internet appliance or a data communication device that may or may not include telephony capabilities.

The illustrated electronic device 852 is an example electronic device that includes two-way wireless communications functions. Such electronic devices incorporate communication subsystem elements such as a wireless transmitter 810, a wireless receiver 812, and associated components such as one or more antenna elements 814 and 816. A digital signal processor (DSP) 808 performs processing to extract data from received wireless signals and to generate signals to be transmitted. The particular design of the communication subsystem is dependent upon the communication network and associated wireless communications protocols with which the device is intended to operate.

The electronic device 852 includes an electronic computational circuit, for example a microprocessor 802, that controls the overall operation of the electronic device 852. The microprocessor 802 interacts with the above described communications subsystem elements and also interacts with other device subsystems such as flash memory 806, random access memory (RAM) 804, auxiliary input/output (I/O) device 838, data port 828, display 834, keyboard 836, speaker 832, microphone 830, a short-range communications subsystem 820, a power subsystem 822, and any other device subsystems.

A battery 824 is connected to a power subsystem 822 to provide power to the circuits of the electronic device 852. The power subsystem 822 includes power distribution circuitry for providing power to the electronic device 852 and also contains battery charging circuitry to manage recharging the battery 824. The power subsystem 822 includes a battery monitoring circuit that is operable to provide a status of one or more battery status indicators, such as remaining capacity, temperature, voltage, electrical current consumption, and the like, to various components of the electronic device 852.

The data port 828 of one example is a receptacle connector 104 or a connector that to which an electrical and optical data communications circuit connector 800 engages and mates, as described above. The data port 828 is able to support data communications between the electronic device 852 and other devices through various modes of data communications, such as high speed data transfers over an optical communications circuits or over electrical data communications circuits such as a USB connection incorporated into the data port 828 of some examples. Data port 828 is able to support communications with, for example, an external computer or other device.

Data communication through data port 828 enables a user to set preferences through the external device or through a software application and extends the capabilities of the device by enabling information or software exchange through direct connections between the electronic device 852 and external data sources rather than via a wireless data communication network. In addition to data communication, the data port 828 provides power to the power subsystem 822 to charge the battery 824 or to supply power to the electronic circuits, such as microprocessor 802, of the electronic device 852.

Operating system software used by the microprocessor 802 is stored in flash memory 806. Further examples are able to use a battery backed-up RAM or other non-volatile storage data elements to store operating systems, other executable programs, or both. The operating system software, device application software, or parts thereof, are able to be temporarily loaded into volatile data storage such as RAM 804. Data received via wireless communication signals or through wired communications are also able to be stored to RAM 804.

The microprocessor 802, in addition to its operating system functions, is able to execute software applications on the electronic device 852. A predetermined set of applications that control basic device operations, including at least data and voice communication applications, is able to be installed on the electronic device 852 during manufacture. Examples of applications that are able to be loaded onto the device may be a personal information manager (PIM) application having the ability to organize and manage data items relating to the device user, such as, but not limited to, e-mail, calendar events, voice mails, appointments, and task items.

Further applications may also be loaded onto the electronic device 852 through, for example, the wireless network 850, an auxiliary I/O device 838, Data port 828, short-range communications subsystem 820, or any combination of these interfaces. Such applications are then able to be installed by a user in the RAM 804 or a non-volatile store for execution by the microprocessor 802.

In a data communication mode, a received signal such as a text message or web page download is processed by the communication subsystem, including wireless receiver 812 and wireless transmitter 810, and communicated data is provided the microprocessor 802, which is able to further process the received data for output to the display 834, or alternatively, to an auxiliary I/O device 838 or the Data port 828. A user of the electronic device 852 may also compose data items, such as e-mail messages, using the keyboard 836, which is able to include a complete alphanumeric keyboard or a telephone-type keypad, in conjunction with the display 834 and possibly an auxiliary I/O device 838. Such composed items are then able to be transmitted over a communication network through the communication subsystem.

For voice communications, overall operation of the electronic device 852 is substantially similar, except that received signals are generally provided to a speaker 832 and signals for transmission are generally produced by a microphone 830. Alternative voice or audio I/O subsystems, such as a voice message recording subsystem, may also be implemented on the electronic device 852. Although voice or audio signal output is generally accomplished primarily through the speaker 832, the display 834 may also be used to provide an indication of the identity of a calling party, the duration of a voice call, or other voice call related information, for example.

Depending on conditions or statuses of the electronic device 852, one or more particular functions associated with a subsystem circuit may be disabled, or an entire subsystem circuit may be disabled. For example, if the battery temperature is low, then voice functions may be disabled, but data communications, such as e-mail, may still be enabled over the communication subsystem.

A short-range communications subsystem 820 provides for data communication between the electronic device 852 and different systems or devices, which need not necessarily be similar devices. For example, the short-range communications subsystem 820 includes an infrared device and associated circuits and components or a Radio Frequency based communication module such as one supporting Bluetooth® communications, to provide for communication with similarly-enabled systems and devices, including the data file transfer communications described above. A wired interface 840 and connector 842 can be provided, configured to support any known wired communication protocol, for example USB.

A media reader 860 is able to be connected to an auxiliary I/O device 838 to allow, for example, loading computer readable program code of a computer program product into the electronic device 852 for storage into flash memory 806. One example of a media reader 860 is an optical drive such as a CD/DVD drive, which may be used to store data to and read data from a computer readable medium or storage product such as computer readable storage media 862. Examples of suitable computer readable storage media include optical storage media such as a CD or DVD, magnetic media, or any other suitable data storage device. Media reader 860 is alternatively able to be connected to the electronic device through the Data port 828 or computer readable program code is alternatively able to be provided to the electronic device 852 through the wireless network 850. Sensors 870 can be provided either internal or external to a housing of device 300/800, of any of the various types and functions as described herein.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A method of identifying spaces on shelves which are not full of objects, comprising:
identifying a marker having known dimensions, the marker located proximate a shelf containing objects;
obtaining an image of the shelf including the marker, using a device having a camera;
executing software stored on non-transitory media using a processor of at least one of the device having a camera and a computer, the software configured to
analyze the image to identify the marker;
analyze the image to identify the shelf;
analyze the storage area of the shelf to identify vacant areas of the shelf represented by a lower light intensity relative to adjacent areas;
determine a location of the vacant areas with respect to the shelf;
determine the size of the vacant areas using the actual size of the marker and the size of the marker in the image, to generate a scale which can be applied to the vacant area; and
process the determined information and stored information pertaining to the objects to determine what objects are missing from the vacant areas.

2. The method of claim 1, wherein the software is executed upon a server, and further including transmitting the image from the device having a camera to the server.

3. The method of claim 1, wherein a plurality of markers are positioned proximate the shelf.

4. The method of claim 3, wherein the markers are positioned at regularly spaced intervals.

5. The method of claim 4, wherein a distance between markers proximate the shelf is known, and the known information is used to develop a scale for determining distances in the image.

6. The method of claim 1, wherein the marker includes a pattern, and the pattern is selected to be distinct from patterns found on the objects.

7. The method of claim 1, wherein the marker includes markings which can be analyzed by the software to determine information pertaining to at least one of a location of the marker, an identity of the marker, information pertaining to the shelf, and information pertaining to the objects.

8. The method of claim 1, wherein the software is further configured to determine the size of an area of actual vacant space on the shelf that is represented by a determined vacant space in the image.

9. The method of claim 1, wherein the software is further configured to apply a transformation algorithm to a representation of the marker within the image, to cause the representation to accurately represent a known true shape of the marker, and to then apply values obtained from the transformation algorithm to a representation of a vacant area to determine a true shape of the vacant area.

10. The method of claim 9, wherein the software is further configured to determine the size of an area of vacant space on the shelf that is represented by the determined true shape of the vacant area in the image.

11. The method of claim 1, wherein the software is further configured to:
determining the sizes of vacant areas in the image;
applying a transformation algorithm to a representation of the marker within the image, to cause the representation to accurately represent a known true shape of the marker, in order to obtain values corresponding to the required transformation; and
using the obtained values to alter the sizes of the vacant areas to obtain the actual sizes of the vacant areas.

12. The method of claim 1, wherein the image is obtained from a stream of images that the camera has captured in a video.

13. The method of claim 1, wherein the software is further configured to determine which objects to place in the vacant areas.

14. The method of claim 13, wherein determining which objects to place includes assigning a priority to the order in which objects are placed, priority being given to objects corresponding to vacant areas which are large relative to other vacant areas.

15. The method of claim 13, wherein data corresponding to a determination of which objects to place in the vacant areas is used to calculate future demand for objects.

16. The method of claim 1, wherein a plurality of images are obtained, and further including using a drone to capture the images.

17. The method of claim 1, wherein the marker is placed proximate the shelf in order to be visible within the image.

18. The method of claim 1, wherein the processor is further configured to de-skew the image using a known shape of the marker.

19. A method of identifying spaces on shelves which are not full of objects, comprising:
placing a marker bearing a pattern, the marker having known dimensions, proximate a shelf containing objects;
obtaining an image of the shelf including the marker, using a device having a camera;
executing software stored on non-transitory media using a processor of at least one of the device having a camera and a computer, the software configured to
analyze the image to identify the marker;
analyze the image to identify the shelf;
identify areas of the shelf in relation to a planogram;
analyze the storage area of the shelf to identify vacant areas of the shelf by comparing adjacent areas of the shelf with reference to the planogram, and if the planogram indicates adjacent areas are intended to contain the same product but the corresponding adjacent areas of the image appear different, determining that at least one row includes a vacant area;
communicate the location of the vacant areas for subsequent restocking.

20. A method of restocking product on store display shelves, comprising:
identifying a marker proximate a shelf containing objects;
at predetermined time intervals, obtaining an image of the shelf including the marker, using a device having a camera;
executing software stored on non-transitory media using a processor, the software configured to
analyze the image to identify the marker;
use the marker location to identify areas corresponding to a planogram;
compare stored image data of a product at an identified area that is fully stocked with image data obtained at a time interval, and if the stored image and the image data obtained at a the time interval are not the same, designating the identified area and product as requiring restocking.
